(19) United States
(12) Patent Application Publication
(10) Pub. No.: US 2008/0065403 A1
(43) Pub. Date: Mar. 13, 2008

(54) System for analyzing and reducing desynchronosis stress and other adverse effects of air travel

(76) Inventor: Ann Eilbracht Thompson, (US)

Correspondence Address: ANN E THOMPSON, 158 BANK ST SE, MINNEAPOLIS, MN, 55414, US

(21) Appl. No.: 11/895,416

(22) Filed: Aug. 24, 2007

Related U.S. Application Data
(60) Provisional application No. 60/839,657, filed on Aug. 24, 2006.

(51) Int. Cl. G06Q 99/00

(52) U.S. Cl. 705/1

(57) ABSTRACT

A computer implemented software system provides method and process that enables calculation of circadian rhythm to enable assessment, evaluation and recommendation for therapy or treatment of travelers. Further, the system enables health index, travel index and feeling index measurements to evaluate and recommend treatment options based on assessment modules.

### CROSS REFERENCE TO PRIORITY APPLICATION

This application claims priority to provisional application Ser. No. 60/839,657 filed on Aug. 26, 2006 and entitled, “A system for analyzing and reducing desynchronosis stress, impact and other adverse physical effects of air travel.”

### TECHNICAL FIELD

The invention relates generally to a computer implemented software system method and process that enables assessment, evaluation and recommendations of therapy or treatment based on various physical, mental and emotional state of clients.

### BACKGROUND

Jet lag is a common outcome of air travel when a traveler crosses over two or more time zones. Particularly since travelers are likely to spend many hours in an airplane cabin with low air pressure and little humidity. While various activities in airports may help reduce jet lag between connecting flights (e.g. walking, drinking water), no systematic process currently exists to help the weary traveler determine the best options to reduce desynchronosis.

Jet lag affects a large number of travelers and aircrew. Jet lag is caused, in part, by desynchronization of the biological clock. It usually occurs when a person drastically changes the sleep-wake cycle, as when crossing several time zones during travel. Jet lag is characterized by fatigue, early awakening or insomnia, headache, fuzzy thinking, irritability, constipation, general malaise, slower reflexes, gastrointestinal distress, memory loss and reduced immunity, among others.

Other factors exacerbate jet lag. Humidity levels of less than 25 percent are the common in the airplane cabin. This is due to the extremely low humidity levels of the outside air supplied to the cabin. The low humidity can cause drying of the nose, throat and eyes and it can irritate wearers of contact lens. When a person sits upright and inactive for a long period of time, several things can happen.

For example, the central blood vessels in the legs can be compressed, making it harder for the blood to get back to the heart. Further, muscles can become tense, resulting in backaches and a feeling of excessive fatigue during, and even after the flight. Moreover, the normal body mechanism for returning fluid to the heart can be inhibited and gravity can cause the fluid to collect in the feet, resulting in swollen feet after a long flight. Furthermore, some studies have concluded that prolonged immobility may be a risk factor in the formation of blood conditions may increase the risk of formation of blood clots if associated with prolonged immobility.

Medical research indicates that factors that may create an increased risk of blood clots in the legs include:

Personal or family history of DVT: Recent surgery or injury, especially to lower limbs or abdomen; blood disorders leading to increased clotting tendency; immobilization for a day or more; age above 40 years; estrogen hormone therapy, including oral contraceptives; pregnancy; tobacco smoking; former or current malignant disease; obesity; dehydration; heart failure and varicose veins.

The typical air traveler's symptoms are generally worse when flying in an easterly direction, and it can take as long as one day for each time zone crossed in order to fully recover. Older people have an even tougher time adjusting to these changes than younger people. In recent years travelers have expressed more difficulty with jet lag because of more international trips and staying fewer days at their destination. Business travelers are more likely to have difficulty concentrating, remembering important facts and reacting quickly to new stimuli. As this trend continues, travelers and businesses will come to recognize the significant negative impact of jet large on the economy and on personal health.

Accordingly, there is a need to reduce desynchronosis including mental and physical effects of long air travel, by implementing several types of therapies including stretching, meditation, relaxation, artificial sunlight, darkness and similar therapeutic treatments based on an assessment of physical, medical and mental conditions and needs of the traveler. The present invention implements a circadian rhythm calculator and analyzes health, travel, feeling and similar indices to determine the most appropriate therapies and/or treatment.

### BRIEF DESCRIPTION OF THE DRAWINGS

FIG. 1: A block diagram representing the general functional algorithmic outline and high level program logic of the elements of the invention.

FIG. 2A through 2A′: represents a logic diagram of one aspect of the invention where a circadian cycle calculation is executed.

FIG. 3: A block diagram representing the health index data management aspect of the invention for integration with data into an assessment module.

FIG. 4: A block diagram representing the travel index data management aspect of the invention.

FIG. 5: A block diagram representing the feeling index data management aspect of the invention.

FIG. 6: A block diagram representing the treatment assessment data management aspect of the invention.

FIG. 7: A logic diagram for the data management for assessment and recommendation of a treatment regimen.

### DETAILED DESCRIPTION

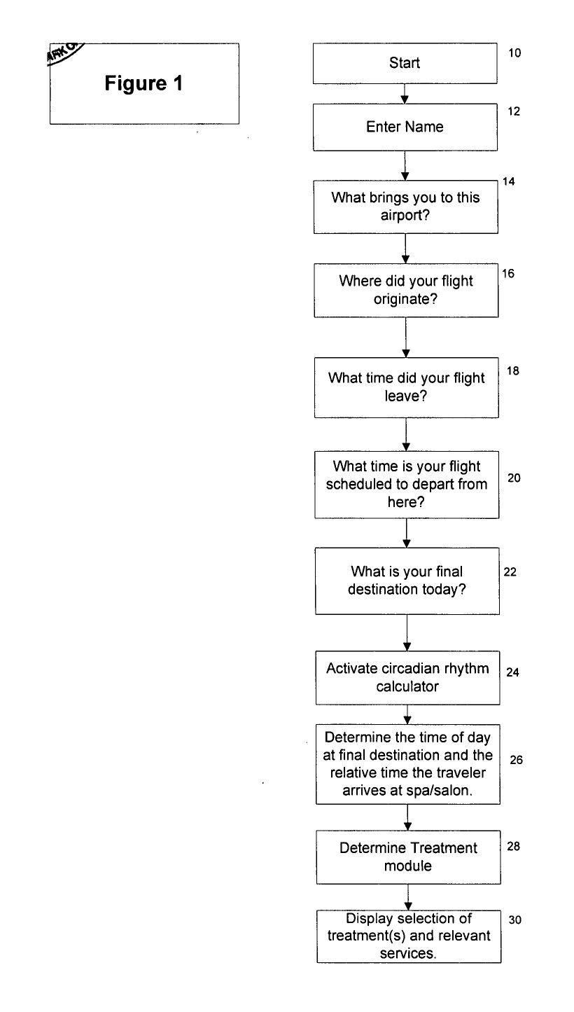

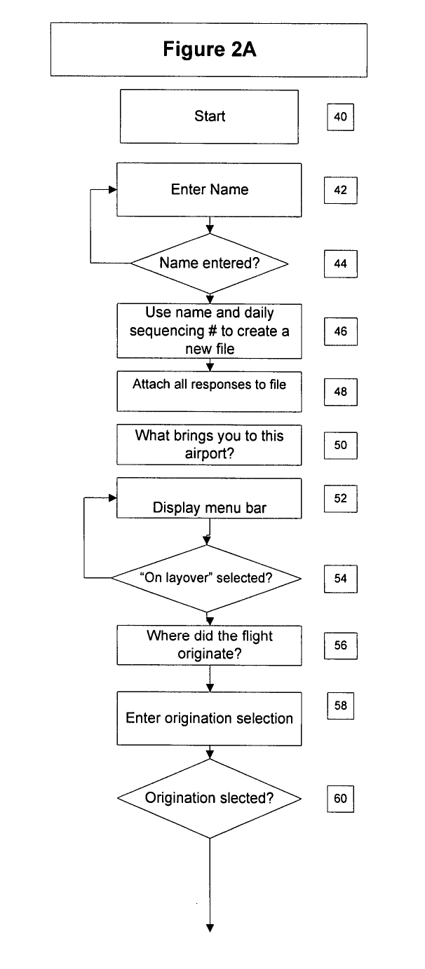

FIG. 1 is a block diagram depicting the algorithmic outline of the present invention. Specifically, the system is initiated at step 10 and subsequently the user is prompted to enter his/her name at step 12. Thereafter, under step 14 the user is asked what their purpose is for being at the airport. This is an important query to distinguish between travelers and people who are waiting for travelers at the airport or may be engaged in non-travel activities at the airport. Assuming the response by a traveler, under step 16, the origination of the flight is entered. Further, under step 18, the traveler is asked to enter the time the origination flight left the airport. Under step 20, the next flight information is collected. Further, under step 22 the final geographic destination for the day is entered. There after, the circadian rhythm calculator is initiated under step 24. Based on information provided, the system software calculates the time of the traveler's arrival at his/her final destination and relative time the traveler will arrive at a health or treatment spa center at the airport under step 26. The system also determines the most appropriate treatment module under step 28. Once a treatment module is selected the treatment regimen and relevant services are displayed under step 30.

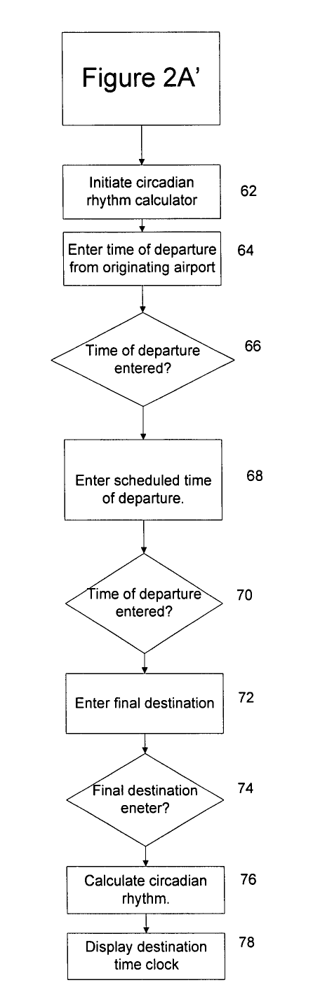

FIG. 2A-2B is a more detailed logic diagram representing a process of traveler data collection and circadian rhythm calculation process. The system is initiated at step 40 and at step 42. The user/traveler is required to enter his/her name. Decision block 44 ensures that the name is entered or the program terminates after failure to enter a name. Under step 46 user permission is acquired to create a new file. Under step 48 all responses are attached to the newly created file. Subsequently, under step 50 the traveler is asked their purpose for being at the airport. Thereafter, a menu bar is displayed under step 52. At decision block 54 the system checks if the traveler has selected “on layover” from the menu displayed in step 52. If not, the logic sequence enters into a loop which will end the program after a preset period if no menu has been selected out of the main menu. If layover is selected, the logic proceeds to step 56 to ask where the flight originated and the information entered in step 58. Subsequent decision block 60 asks if flight origination has been entered. If not the logic sequence stays in a loop which could be terminated after a predetermined time. However, if the origination information has been selected, the circadian calculator is initiated under logic step 62. Under decision block 66 the system logic checks if time of departure has been recorded or else the system stays in a loop which may terminate the program after a predetermined time. Subsequently time of departure is entered under step 68. Under decision block 70, the system checks if the time of departure has been entered. Again, the system stays in a loop or will be terminated after a predetermined period of time if the time of departure is not entered. Subsequently, the system requires the user to enter information on final destination under step 72. Under decision block 74, final destination must be entered to proceed to the next step. Thereafter, under step 76, the circadian rhythm is calculated. Subsequently, the destination time clock is displayed under step 78.

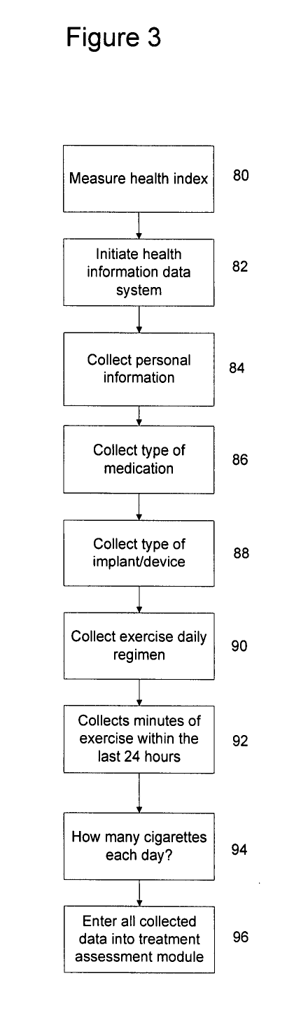

Referring to FIG. 3, a high level logic diagram represents the health index data management aspect of the invention. Specifically, under step 80, the health measurement index is initiated. Subsequently, the health information data system is initiated under step 82. Thereafter, personal information is collected under step 84. Type of medication is registered under step 86 and if the user wears any kind of device including implantable devices that information is registered under step 88. Further, the traveler's exercise daily regimen data is collected at step 90 and the minutes or hours of exercise conducted in the last 24 hours is collected under step 92. Also, if the traveler smokes cigarettes the information is entered under step 94. All the collected information is entered into a treatment assessment module under step 96.

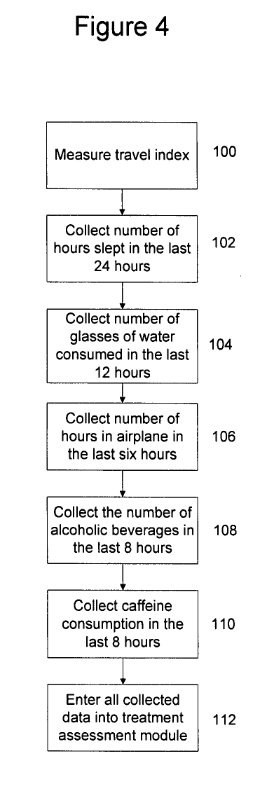

FIG. 4 represents yet another high level logic diagram representing the travel index data management aspect of the invention. The travel index measurement system is initiated at step 100. Under step 102, the number of hours slept in the last 24 hours by the traveler is entered. Further, fluid intake including the number of glasses of water consumed in the last 24 hours is entered under step 104. Further, under step 106 information regarding the traveler's time spent in an airplane during the last six hours is entered. Under step 108 the traveler's consumption of alcoholic beverages in the last eight hours is entered. Further, caffeine consumption in the last 8 hours is entered under step 100. Subsequently, all the information is collected under step 112 for processing with other data in the treatment assessment module.

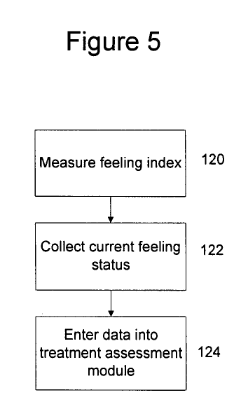

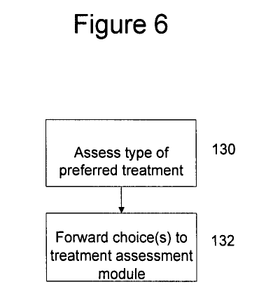

FIG. 5 represents the feeling index measurement data management aspect of the invention. The system is initiated to measure a feeling index under step 120. Under subsequent step 122, the traveler's current feeling status is collected and all the information is entered into the treatment assessment module. Similarly, FIG. 6 represents the logic to assess the type of preferred treatment. Specifically, the type of preferred treatment is considered under step 130 and the information forwarded to treatment assessment module under step 132.

FIG. 6?

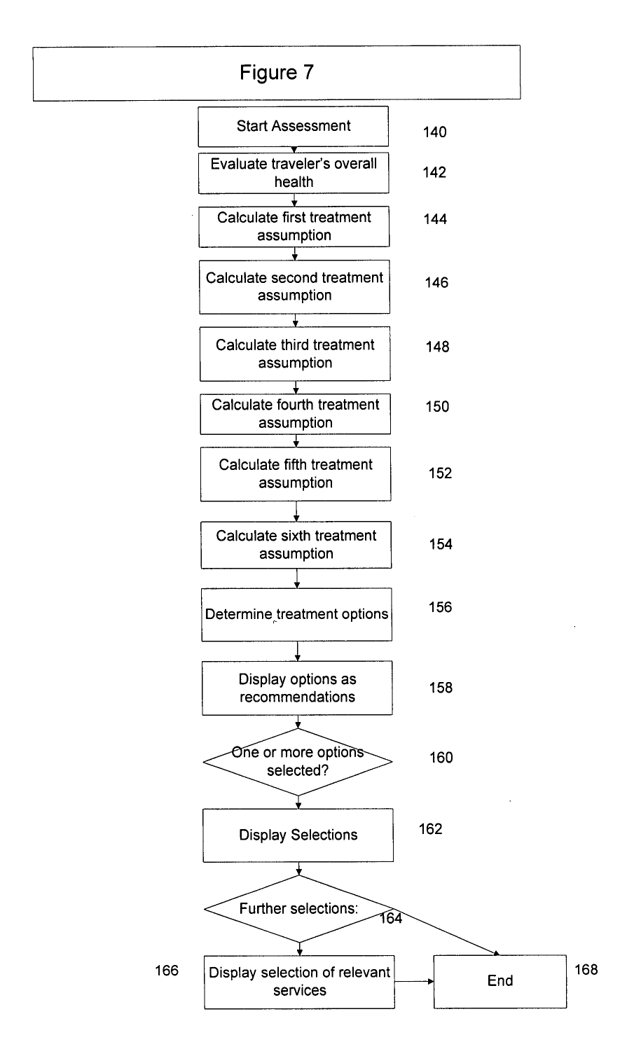

FIG. 7 represents a logic diagram in which the overall assessment is made based on all data into the various assessment modules. The system is initiated under step 140. Under step 142 the evaluation of the traveler's overall health is started. In this regard, first under step 144 the treatment assumptions are calculated. Thereafter, second, third, fourth, fifth and sixth treatment assumptions are calculated under steps 146, 148, 150, 152 and 154, respectively. Under rule 156 treatment options are determined based on the calculation made. The results are displayed as recommendations under step 158. Under decision block 160 the traveler is required to select at least one treatment option. If no option is selected into a loop which may interrupt the operation after a certain period of time if no elections have been made. After a selection is made, the selected option is displayed under step 162. Thereafter, the system asks if the traveler requires further services under decision block 164. If the selection is made for further service, a menu of relevant services, based on the calculation results, is displayed. In the alternate, if no further services are required the program ends.

As generally depicted in FIGS. 1 though 7 the following is a general depiction and example of what questions will appear on the let Lag Assessment automated form.
1. Name
   Question Format: narrative Box
   Programming: use name and unique daily sequencing number to create a new file. Attach all responses to this file.
2. What brings you to the Minneapolis-St. Paul International Airport today?
   Question Format: Drop down choices of “on layover between two flights”, Preparing for first flight of today”, “Minneapolis is final destination today” or “I work at, or am visiting the airport”.
   Programming: If the traveler chose “On layover between two flights”, the traveler will be asked for the following information:
3. A. Where did your flight into Minneapolis originate?
   Question Format Drop down box with all the names of cities and their airport abbreviations for airports that connect with MSP.
   Programming: The program will enter airport abbreviation in the circadian rhythm time calculator as “Origination Location”.
   B. What time did you leave (originating airport copied from previous response)? Question Format: Drop down box with 48 time choices (every hour and half hour denoting AM and PM).
   Programming: The program will enter the time selected into the circadian rhythm time calculator as “origination State Time” (see page 2). If the traveler chose “On layover between two flights” or “preparing for first flight today”, the program will ask the traveler the following questions:
4. A. What time is your flight scheduled to leave (NAME OF AIRPORT)?
   Question Format: Drop down box with 48 time choices (every hour and half hour, denoting AM and PM)
   Programming: Enter the time selected into the Circadian Rhythm Time Calculator and the Treatment Assessment assumptions sections “Amount of Treatment Time Available”. (see page 5)
   B. What is your final destination today?
   Question Format: Drop down box with names and abbreviations for all airports.
   Programming: Enter the airport abbreviation into the circadian rhythm time calculator as “Destination Location”.
   If the traveler chose “I work at, or am visiting the airport today”, no data needs to be entered into the Circadian Rhythm Time Calculator.

Circadian Rhythm Time Calculator
The circadian rhythm time calculator will use the flight data and departure and arrival time data to determine the total length of time the traveler will be traveling, and will determine what time of day the traveler will arrive at his/her final destination. The time calculator will then determine what time of day it will be at the final destination, and the relative time the traveler arrives at the spa, salon or fitness center (assuming Destination Time clock).
The time calculator will rely on a global time keeping system via a hyperlink to convert starting, layover and destination times to a common measure. The time calculator will then forward the following two measures to the treatment assessment module: “Current time of day in final destination” and “Time of day it will be when the traveler arrives in the final destination”.

Your General Health Information
5. GENDER
   Question Format Radial buttons with male or female
6. HEIGHT (optional, depending on treatment selections)
   Question Format: Drop down box for feet (4-7) and for inches (12 choices)
7. WEIGHT (optional, depending on treatment selections)
   Question Format: Drop down box with weight ranges in 10 pound increments starting at 95 pounds and going as high as 300 pounds.
8. AGE (optional, depending on treatment selections)
   Question Format Narrative box for numeric entry only
   Programming: Using gender, height, weight and age, compare these data to established matrix that determines if the person is underweight, within a normal weight range, or overweight. This determination will be forwarded to the treatment assessment module as “Weight”.
9. WHAT TYPE OF PRESCRIPTION MEDICATION(S) DO YOU TAKE? FOR EACH MEDICATION, WHAT TIME OF DAY DO YOU NORMALLY TAKE YOUR PRESCRIBED MEDICATION(S)?
   Question Format: Drop down boxes with general medical types (e.g. hypertension, cholesterol reduction, etc). Drop down box next two each medication type selected with choices of times from midnight to 11:45 pm, on every 15 minute increment. Allow for multiple doses per day.
   Programming: Determine need to adjust medication administration time, based on the circadian rhythm calculator and a list of most common medications.
10. DO YOU HAVE ANY MEDICAL DEVICES IMPLANTED IN YOUR BODY?
   Question Format: Drop down boxes with a list of the most common medical implants (e.g. pacemaker, diabetes regulator, etc.)
   Programming: Forward type of device, if any, selected to the Treatment Assessment Module for “Readiness for Activity”.
11. HOW MUCH EXERCISE DO YOU GET ON AN AVERAGE DAY?
   Question Format: Drop down box with choices on 15 minute intervals (0-120 minutes)
12. HOW MANY MINUTES OF EXERCISE HAVE YOU COMPLETED WITHIN THE LAST 24 HOURS?
   Question Format: Drop down box with choices on 15 minute intervals (0-120 minutes)
   Programming: Using responses from questions 11 and 12, the program will subtract the amount of exercise completed in the last 24 hours from the average daily minutes and forward the difference to the Treatment Assessment Module as “Readiness for Activity”.
13. HOW MANY CIGARETTES DO YOU SMOKE EACH DAY?
   Question Format (OPTIONAL): Narrative box for 0-2 digit numeric entry
   Programming: Based on number of cigarettes normally smoked, determine need for increased oxygen intake. Forward this information to Treatment Assessment Module as “Need for Oxygen”.

Today's Travel Experience
14. HOW MANY HOURS HAVE YOU SLEPT IN THE LAST 24 HOURS?
   Question Format: Drop down box with numerical choices (0-15)
   Programming: Subtract the number of hours in this response from 8 hours and forward result to treatment assessment module as “Readiness for Activity”.
15. HOW MANY 12 OUNCE GLASSES OF WATER HAVE YOU DRUNK IN THE LAST 12 HOURS?
   Question Format: Drop down box with numeric choices (0-12 glasses)
   Programming: Subtract the number in response from 8 hours and forward result to treatment assessment module as “Need for Hydration”.
16. HOW MANY HOURS WERE YOU IN AN AIRPLANE CABIN IN THE LAST SIX HOURS?
   Question Format: Drop down boxes with choices from 0 hours-6 hours.
   Programming: For each hour of flight time, add another 12 ounce glass of water to the following calculations for hydration needs.
17. HOW MANY ALCOHOLIC BEVERAGES HAVE YOU HAD IN THE LAST 8 HOURS?
   Question Format: Drop down box with numeric choices of 0-6 or more.
18. HOW MANY CAFFEINATED BEVERAGES HAVE YOU HAD IN THE LAST 8 HOURS?
   Question Format: Drop down box with numeric choices of 0-6 or more.
   Programming: Add the answers to questions 16, 17 and 18 and divide by two. Subtract this result from question 15 and enter it as “Need for Hydration” in Treatment Assessment module.

How You are Feeling Now?
19. CHECK ALL CHOICES THAT APPLY TO YOUR CURRENT STATUS:
   Question Format Radial buttons with these choices: Tired, Sleepy, Energetic, Rested, Tense, Stiff, Relaxed, Sore Muscles, Numb or Tingling in my extremities, Thirsty, Constipated, Hungry, Upset Stomach, Bloated, Retaining Water, Disoriented, Irritable, and Diminished Mental Acuity.
   Programming: All checked items are forwarded to the treatment assessment module as “Current Status”.
20. WHICH OF THE FOLLOWING TREATMENTS ARE MOST ATTRACTIVE TO YOU NOW?
   Question Format Radial buttons with these choices: (The list will vary depending upon the specific offerings at the spa, salon or fitness center) Full body light therapy, Upper body light therapy, full body massage with masseuse, full body massage with a water-motion-temperature massage, chair massage, head massage, manicure or pedicure, instructor led yoga class, Pilates instruction (CD and headset), or oxygen treatment.
   Programming: All checked items are forwarded to the treatment assessment module as “Preferred Treatments”.

Treatment Assessment Module
The treatment assessment module will use all of the data forwarded from the various assessment questions to evaluate the traveler's overall health, the traveler's recent physiological experiences, the traveler's circadian rhythm schedule, and their preferences for treatments to recommend a specific treatment plan.
First Treatment Assumption—Time Available in Spa: Time between assessment completion and departure time from the airport will indicate amount of time available for treatment. The specific amount of time needed to get to the departure gate will depend on the gate's proximity to the spa, salon or fitness center. This time will be subtracted from the departure time to allow sufficient time for arrival at the gate.
Second Treatment Assumption—Readiness for Activity: This assumption will describe the traveler's age, number of hours of sleep in last 24 hours, normal daily exercise level compared to today's activity. The traveler will measure his/her blood pressure and heart rate measure, if completing assessment on site.
Third Treatment Assumption—Need for Oxygen: Any traveler who reports smoking more than six cigarettes per day will be encouraged to use the oxygen treatment for at least five minutes. Any traveler who has already spent more than one hour flying that day will also be encouraged to use the oxygen treatment for at least five minutes.
Fourth Treatment Assumption—Need for Hydration: The traveler's fluid intake will be calculated by adding alcoholic beverages and caffeinated beverages, divided in half, and then subtracted from the response to question number 12. Any traveler who reports having a negative fluid intake will be encouraged to begin the spa experience with an eight ounce glass of water, and to consume additional glasses throughout the spa stay, depending on deficiency.
Fifth Treatment Assumption—Need for Circadian Rhythm Adjustment: Based on the results of the Circadian Rhythm Time Calculator, the traveler will be encouraged to spend at least one-half hour in either a light therapy or darkened environment (massage room or yoga studio). If the traveler should be in a darkened environment, and will continue to need a darkened environment, the traveler will also be encouraged to purchase Melatonin for ingestion.
Sixth Treatment Assumption—Preferred Treatment: Based on the traveler's list of current conditions and preferred treatments, the traveler will be encouraged to register for preferred treatments that will decrease negative symptoms.

Treatment Recommendations
Please see recommendations below. Please select the treatment(s) that will most help you reduce your jet lag and enhance your travel activities.
Question Format Radial buttons with an abbreviated list of treatment options, based on algorithm that factors in results of assumptions listed above.
Programming: Based on traveler's choices, determine if further services or products are needed to fulfill the traveler's selection. For example, if the traveler chooses to participate in a one-half hour instructor-led yoga session, the program will let the traveler determine if he/she needs to purchase disposable clothing.
Treatment options can include massage (full body, head, feet and hands), exercise (yoga, Pilates, stretching and weight lifting), tanning, light therapy, oxygen intake, aromatherapy, melatonin, hydration intake and dark sleeping quarters. Other treatments may be added to the list of possible treatments when research shows the treatment is effective at reducing one or more of the symptoms commonly associated with jet lag. The traveler will be able to read a detailed description of the treatment that explains how it can reduce or prevent jet lag, and can learn more about how the treatment can be administered.

The services provided in accordance with the present invention include intelligent software that will guide the traveler to perform the following interactive web-based operations such as for example, without limitation: Seek immediate medical advice if the traveler has a heart rate or a blood pressure that exceeds reasonable safe ranges, select a specific treatment or treatments that have been proven to help reduce the traveler's specific current condition, or that have generally been proven to reduce jet lag. Purchase select treatment(s), purchase any needed supplies for the selected treatment (e.g. comfortable clothing, melatonin, oxygen), and pay for these treatments online using a credit card. Further, the system of the present invention enables access to a web site for holding reservations at the center, custom-designed services and alerts the center about the special needs, if any.

Thus, a system for analyzing and reducing desynchronisis stress and other adverse effects of air travel has been presented in the foregoing description with reference to specific embodiments. It is appreciated that various modifications to the referenced modifications may be made without departing from the scope of the invention as set forth in the following claims.

1. A system for reducing jet lag stress, the system comprising
means for collecting travel information;
means for calculating a circadian rhythm based on the travel information, and
means for displaying selection of treatment and relevant services based on said travel information and said circadian rhythm and said selection of treatment.

2. The system of claim 1 wherein said means for calculating circadian rhythm includes means for collecting time zone changes including past and futurer changes based on origination and destination of trip cycles.

3. The system of claim 1 wherein said means for collecting travel information includes means for gathering demographic data such as travel summary.

4. The system of claim 1 wherein said means for collecting travel information includes means for gathering the traveler's current condition information.

5. The system of claim 1 wherein said means for collecting travel information includes means for gathering information on the traveler's profile.

6. The system of claim 1 wherein said means for calculating includes means for recommending a therapy regimen.

7. The system of claim 1 wherein said means for displaying includes means for providing choices of treatments and/or therapy.

8. The system of claim 5 wherein said means for calculating includes means for getting the traveler's consent to save said traveler's profile for future use and reference.

9. A business method for providing a therapy and relaxation service
at a center in an airport for air travelers, the method comprising
enabling travelers to enter a personal profile pertaining to physiologic and travel factors information;
assessing the therapy needs based on the personal profile and travel factors;
displaying a recommended list of therapies based on the personal profile; and
displaying fees and billing arrangement based on one of each and a combination of therapies selected from the list.

10. The business method of claim 9 wherein the personal profile is gathered remotely.

11. The business method of claim 9 wherein the recommended list of therapies is based on assessment modules.

12. The business method of claim 9 wherein the personal profile is stored for future reference upon consent of the traveler.

13. The business method of claim 9 wherein the center includes a data entry facility.

14. The business method of claim 9 wherein the center includes first aid and external defibrillators for emergency response.

15. The business method of claim 9 wherein the center includes computer enabled communication with hospitals for travelers to access their physicians for consultations.

16. The business method of claim 9 wherein the center includes instructions and user information in various major international languages.

17. A system for recommending a treatment regimen to a client, the system comprising;
means for calculating a circadian rhythm;
means for measuring a health index;
means for measuring a travel index;
means for measuring a feeling index; and
means for assessing type of preferred treatment; wherein said preferred treatment is based on said circadian rhythm, travel index and feeling index.

18. The system of claim 17 wherein said means for calculating a circadian rhythm includes means for calculating projected circadian rhythm based on departure and destination time zones.

19. The system of claim 17 wherein said means for measuring a health index, feeling index and travel index includes means for collecting and analyzing the indices to evaluate overall traveler's health to determine treatment options.
